(19) United States
(12) Patent Application Publication
(10) Pub. No.: US 2007/0126544 A1
(43) Pub. Date: Jun. 7, 2007

(54) Inductive component

(76) Inventors: Tracy Wotherspoon, Monmouthshire (GB); Tim Coombs, Cardiff (GB)

Correspondence Address: ARENT FOX PLLC, 1050 CONNECTICUT AVENUE, N.W., SUITE 400, WASHINGTON, DC, 20036, US

(21) Appl. No.: 11/600,316

(22) Filed: Nov. 16, 2006

(30) Foreign Application Priority Data
Nov. 25, 2005 (GB) 0523969.4

(51) Int. Cl. H01F 5/00; G08B 13/14

(52) U.S. Cl. 336/200; 340/572.7

(57) ABSTRACT

An inductive component comprises a plurality of planar inductive elements connected in parallel and disposed adjacent each other in respective parallel planes so as to have a common magnetic axis. Each element comprise at least one turn of a planar conductor and the elements are separated from each other by one or more insulators. The elements are connected together by interconnections at one or more intermediate points.

### TECHNICAL FIELD

The present invention relates to an inductive component. Such a component may be used, for example, as a loop antenna or choke or in near field coupling devices or tuned circuits.

### BACKGROUND

A known type of inductor is formed on the substrate of a circuit incorporating the inductor, for example by deposition. The inductor comprises one or more turns in a common plane on the surface of the substrate. The or each turn may be in the general shape of a circle or polygon and multiple turn inductors may have the turns arranged in a spiral. Inductors of this type have the advantages that there are no assembly costs, as the inductors are formed directly on the circuit substrate, and tight tolerance of the inductance can be achieved.

If the inductance value required of the inductor cannot be achieved by a single turn, then a multiple turn planar conductor may be deposited. This generally means that the track width of the conductor forming the turns has to be reduced so as to achieve a required inductance value in the area of the substrate available for the inductor. However, this increases the resistance of the inductor so that the “Q” or ratio of complex reactance to resistance is reduced. The resistance is further increased at higher frequencies by the skin effect because the surface area of the conductor decreases if the track width is decreased.

An inductor of this type is typically made by silkscreen printing a conductive ink, such as ESL 9635-BT available from ESL Europe, AGMet Ltd, Reading, UK, onto the substrate. After firing, the thickness of the conductor is typically 12.5 micrometres with a resistivity of 30 mΩ/sq. Thus, such conductors intrinsically have a relatively high resistance, for example as compared with a copper conductor of the same dimensions. Although several such conductors may be printed on top of each other so as to reduce the resistance at lower frequencies, this does not substantially increase the surface area of the conductor so that the resulting inductor would still have a relatively high resistance at higher frequencies where the skin effect is significant.

US 2003/0149461 discloses a spiral inductor formed in two parallel planes with an insulator between the windings. Two sections of the inductor are formed by parallel partial turns connected in parallel to form an arrangement which is said to generate the maximum Q-factor at a desired frequency while increasing the overall inductance and Q-factor without increasing the area occupied by the metal lines.

US2002/0149461, US 2004/0070481 and US 2002/0057171 disclose a transformer with turns formed in different planes. The secondary winding comprises a plurality of identical turns which are connected in parallel. The individual turns are interspersed with primary winding turns which are connected in series and have alternating spiral shapes of opposite directions.

U.S. Pat. No. 5,184,103 discloses a transformer which is said to be intended for a switched-mode power supply. The secondary winding comprises two halves, each of which comprises spaced planar turns connected in parallel. This document therefore anticipates our claims 1 to 3, 8, 12 and 13.

U.S. Pat. No. 5,276,421 discloses a transformer having a secondary winding formed on an “accordion folded” substrate so as to comprise a plurality of planar turns which are connected in parallel.

### SUMMARY

According to the invention, there is provided an inductive component comprising a plurality of planar inductive elements connected in parallel, disposed adjacent each other in respective parallel planes, and having a common magnetic axis, each element comprising at least one turn of a planar conductor with respective ends of the at least one turns being connected together, the elements of the or each adjacent pair being separated by an insulator, characterised in that the at least one turns are connected together at at least one intermediate point of each at least one turn.

The planar conductors of the elements may have substantially the same shapes and sizes and may be geometrically aligned so as to have substantially the same positions and orientations in the respective planes.

The at least one turns may have first ends connected together and second ends connected together by first and second conductive paths, respectively, extending substantially perpendicularly to and between the planes of the or each adjacent pair of elements.

Each at least one intermediate point may divide the respective at least one turn into a plurality of sections of substantially equal lengths.

The at least one intermediate points of the at least one turns may be connected together by at least one further conductive path extending substantially perpendicularly to and between the planes of the or each adjacent pair of elements.

The at least one intermediate points of the at least one turns may be connected together by at least one switch for selectively connecting together or disconnecting the intermediate points.

The at least one turns may be polygonal.

Each of the at least one turns may comprise a plurality of turns arranged as a spiral in the respective plane.

A first of the at least one turns may be deposited on a substrate of a circuit containing the component. The or each insulator and the or each other at least one turn may be deposited on the substrate.

Each at least one turn may comprise a conductive ink.

The component may comprise one of a loop antenna, an inductive coupling, a choke, a tuned circuit and a filter.

It is thus possible to provide an inductive component of improved performance. Such a component is relatively easy and inexpensive to manufacture, for example having the advantages of known planar arrangements. The resistance of the component may be made relatively low and the results of the skin, effect may be reduced so as to provide an inductive component of improved Q, particularly at relatively high frequencies where the skin effect becomes significant.

### BRIEF DESCRIPTION OF THE DRAWINGS

FIG. 1 is a view illustrating an intermediate stage in the manufacture of an inductive component constituting an embodiment of the invention;

FIG. 2 is an exploded view of part of a component constituting an embodiment of the invention;

FIG. 3 is an exploded view of the whole inductive component of FIG. 2 constituting an embodiment of the invention;

FIG. 4 is a view illustrating part of an inductive component constituting another embodiment of the invention;

FIG. 5 is an exploded view of the inductive component of FIG. 4; and

FIG. 6 is an exploded view of the whole inductive component of FIG. 4 constituting another embodiment of the invention.

Like reference numerals refer to like parts throughout the drawings.

### DETAILED DESCRIPTION

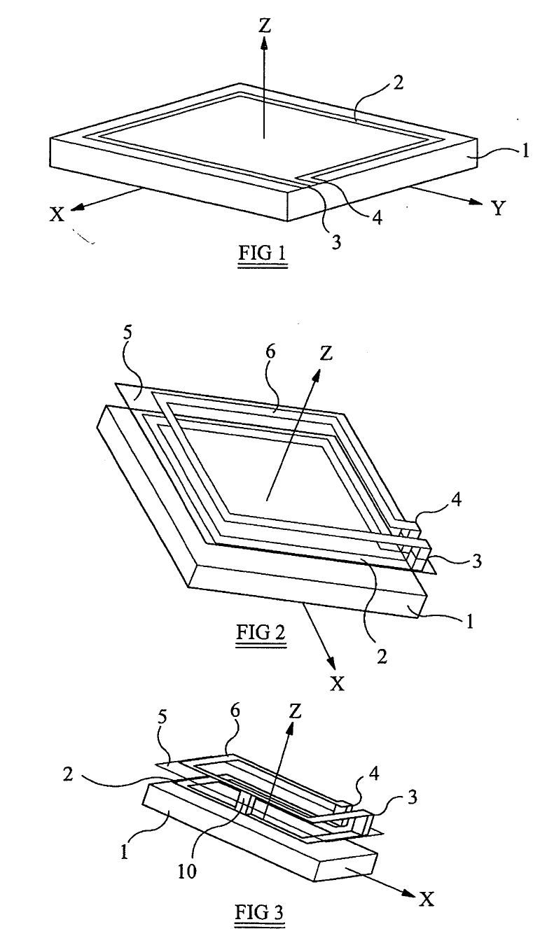

The drawings illustrate various inductive components in the form of printed inductors or coils. For example, the inductor illustrated in FIGS. 1 to 3 is formed on an alumina substrate 1 which, in this example, is of square shape with sides which are 10 mm in length and with a thickness of 1 mm. The inductor comprises what is effectively a single turn coil of square shape having an inductance of a few tens of nano Henries (nH) at DC and relatively low frequencies. This inductor is intended for use at frequencies up to 1 GHz or beyond.

As shown in FIG. 1, the inductor is provided or formed by first depositing a substantially square turn 2 having ends or terminals 3 and 4 for connection into an electronic circuit. The square turn 2 is formed by silk screen printing a conductive ink, such as ESL 9635-BT, onto the substrate 1. This assembly is then fired so as to dry the ink, which forms a film typically having a thickness of about 12.5 micrometres and a resistivity of 30 mΩ/sq.

An electrically insulating layer 5 is formed on top of the turn 2 and the substrate 1 by any suitable technique. A suitable material for the layer 5 is the dielectric insulator ESL 4913-G available from AGMet Ltd (as hereinbefore) A second square turn 6 is formed on top of the insulting layer 5, for example using the same technique as was used to form the turn 2. The turn 6 has the same shape and size as the turn 2 and directly overlays it so as to be superimposed directly above the turn 2 but separated electrically therefrom by the insulating layer 5. Both first ends of the turns 2 and 6 are connected together by the terminal 3, which extends perpendicularly to and between the planes containing the turns 2 and 6. Similarly, the other ends of the turns 2 and 6 are connected together by the terminal 4. Thus, both of the turns 2 and 6 are connected in parallel and are in very close proximity to each other so as to share a common magnetic axis. The inductance of the inductor shown in FIG. 2 is thus equal to the inductance of a single turn. However, the cross-sectional area of the inductor has been substantially doubled as compared with a conventional type of single turn inductor of the same inductance, so that the resistance of the inductor has been substantially halved. Further, the surface area of the inductor has been substantially doubled as compared with a conventional type of single turn inductor so that the reduction in resistance of the inductor is present at relatively high frequencies where the skin effect is present. The inductor shown in FIG. 2 thus has a lower resistance and hence a higher Q and this improvement is maintained at relatively high frequencies where the skin effect becomes significant or dominant.

In order to maintain the desired inductive value and reduce capacitive coupling between the turns 2 and 6, the turns are shorted together at one or more intermediate points. For example, FIG. 3 illustrates an inductor with the turns 2 and 6 shorted together not only at their ends but also at an intermediate point illustrated at 10. These interconnections are made by conductive paths extending perpendicularly to the planes of the turns 2 and 6 and passing through the insulating layer 5. Although a single connection 10 is illustrated in FIG. 3, any desired number of such connections may be provided. The positions of the interconnections may, for example, be chosen so as to divide the turns into sub-sections of substantially identical lengths. The interconnections may be formed by printing and firing techniques to provide the conductive paths through holes in the insulating layer 5.

Because the presence and positioning of the intermediate interconnections affect the resonant behaviour of the inductor, use may be made of this in order to perform limited “tuning”. For example, instead of providing permanent conductive paths between adjacent planar conductors at intermediate points, these points may be interconnected by electronic switches. Such switches may then be controlled, for example, to tune a loop antenna formed by the inductor or to provide a form of tuneable band-pass or band-reject filter. The conductive path or electronic switch is illustrated by the interconnection at the intermediate point 10 in FIG. 3.

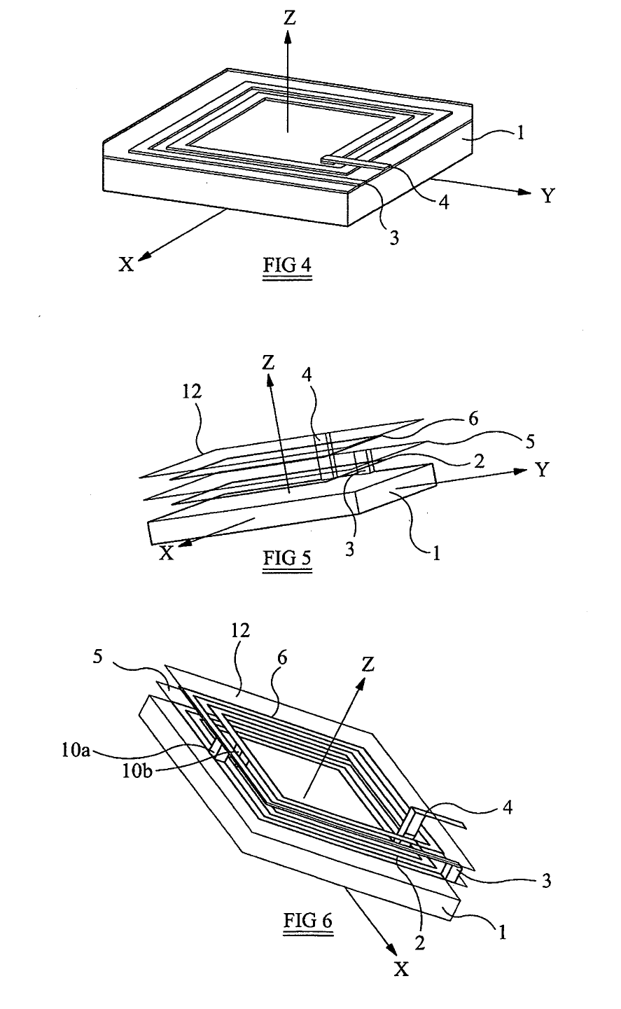

In order to provide an inductor of higher inductance on a substrate of substantially the same size, it is possible to provide more than one turn in each layer. For example, FIG. 4 illustrates an inductor comprising two turns and FIG. 5 illustrates in more detail the structure of this inductor. In this case, because the end of the two-turn planar layers connected to the terminal 4 is inside the turns and is not readily accessible at the edge of the substrate 1, a further insulating layer 12 is formed on top of the turn 6 and the inner end of the turn extends through this layer to be connected to the terminal 4.

Although components having only two planar inductive elements separated by an insulating layer have been illustrated, any number of such planar elements connected in parallel may be provided in accordance with the requirements of the inductive component.

FIG. 6 illustrates how two intermediate interconnecting conductive paths are formed in the case of the “two turn” component of FIG. 5. Intermediate interconnections 10a and 10b are formed at or near the mid points of the turns of each two-turn planar inductive element.

Inductive components of this type may be formed as separate components or as parts of electronic circuits, for example by being formed on the same substrate as all or part of the electronic circuit. Thus, such inductive components may be formed by thick film printing, during silicon wafer manufacture, in printed circuit board laminations or in three dimensional chip scale packaging. Any suitable processes allowing layered structures to be made and any suitable processes for conductor deposition or formation may be used.

Inductive components of this type have many possible uses. For example, such components may be used as: chip inductors, coils or chokes; printed inductors, coils or chokes; or integrated circuit inductors, coils or chokes. Such components may be used as loop aerials, for example for near field communication, or in inductive loop and inductive coupled systems. Specific applications of such components include radio frequency identification devices, smart card aerials and devices for use in electromagnetic interference and contamination suppression.

What we claim is:

1. An inductive component comprising: a plurality of planar inductive elements connected in parallel, disposed adjacent each other in respective parallel planes, and having a common magnetic axis, each said element comprising at least one turn of a planar conductor said at least one turns having first ends connected together and second ends connected together; and an insulator separating each adjacent pair of said elements, each said at least one turns having at least one intermediate point and said at least one turn being connected together at said at least one intermediate point.

2. A component as claimed in claim 1, in which said planar conductors of said elements have substantially a same shape and size and are geometrically aligned so as to have substantially a same position and orientation in said respective planes.

3. A component as claimed in claim 1, in which said at least one turns have first ends connected together and second ends connected together by first and second conductive paths, respectively, extending substantially perpendicularly to and between the planes of the or each adjacent pair of elements.

4. A component as claimed in claim 1, in which each said at least one intermediate point divides respective said at least one turn into a plurality of sections of substantially equal lengths.

5. A component as claimed in claim 1, in which said at least one intermediate points of said at least one turns are connected together by at least one further conductive path extending substantially perpendicularly to and between said planes of each said adjacent pair of said elements.

6. A component as claimed in claim 1, comprising at least one switch for selectively connecting together or disconnecting said at least one intermediate points of said at least turns.

7. A component as claimed in claim 1, in which said at least one turns are polygonal.

8. A component as claimed in claim 1, in which each of said at least one turns comprises a plurality of turns arranged as a spiral in said respective plane.

9. A component as claimed in claim 1, comprising a circuit containing said component and having a substrate a first of said at least one turns being deposited on said substrate.

10. A component as claimed in claim 9, in which said insulator and another of said at least turns are deposited on said substrate.

11. A component as claimed in claim 1, in which each said at least one turn comprises a conductive ink.

12. A component as claimed in claim 1, comprising one of a loop antenna, an inductive coupling, a choke, a tuned circuit and a filter.
